(19) United States
(12) Patent Application Publication
(10) Pub. No.: US 2007/0169582 A1
(43) Pub. Date: Jul. 26, 2007

(54) Quick-release hanging-plate latch structure for an article bag or basket on a bicycle handle bar

(75) Inventors: Chien-Ping Lien, Taipei Hsien (TW); Kuo-Ping Ho, Taipei (TW)

Correspondence Address: TROXELL LAW OFFICE PLLC, SUITE 1404, 5205 LEESBURG PIKE, FALLS CHURCH, VA, 22041, US

(73) Assignee: Kuo-Ping Ho

(21) Appl. No.: 11/335,647

(22) Filed: Jan. 20, 2006

(51) Int. Cl. B62K 21/26

(52) U.S. Cl. 74/551.9

(57) ABSTRACT

A quick-release hanging-plate latch structure for an article bag or basket on a bicycle handle bar includes primarily an article bag or basket, an assembling plate, a hanging plate, and a latch seat. The assembling plate can be fixed with the article bag or basket by latching the hanging plate to the assembling plate, so as to facilitate a firm assembling with the latch seat on the bicycle handle bar or disassembling by pressing down a push button, thereby being provided with a quick-release function and facilitating carrying the article bag or basket on the bicycle for going out for shopping.

### BACKGROUND OF THE INVENTION

(a) Field of the Invention

The present invention relates to a quick-release hanging-plate latch structure for an article bag or basket on a bicycle handle bar, and more particularly to a latch structure which is used for an article bag or article basket on a bicycle, such that the article bag or article basket can be conveniently latched on a handle bar of the bicycle, and can be conveniently disassembled for carrying personally, which is provided with a convenience and practicability in usage.

(b) Description of the Prior Art

Riding a bicycle is basically provided with effects of environmental protection and exercising to keep health. Population of people riding the bicycle frequently spans an extremely wide range, including young school kids to old-aged people. The bicycle is not only a tool for exercising, but also an extremely good transportation tool for an office worker. For example, a paper boy will ride a bicycle to deliver newspapers door by door, a postman will ride a bicycle to deliver mails street by street, a milk delivery person will ride a bicycle to dispatch morning milk, and a bill receiver will take a bicycle to notify customers door by door. All the aforementioned are the examples that some specific person will ride the bicycle frequently.

Accordingly, as these people will use the bicycle as a transportation tool, it is naturally that an article bag or basket should be hung on the bicycle for emplacing articles. However, a conventional method for fixing the article bag is to simply hang the article bag on the bicycle without efficiently fixing it. Therefore, it is inevitable that a vibration will be generated and the bicycle will not be stable during riding the bicycle.

Accordingly, the inventor has already applied a U.S. Pat. No. 6,062,053, “Quick-Release Locking Device for Locking an Article Basket/Bag on a Bicycle Handle Bar”(as shown in FIGS. 14 to 16). This invention includes a main body 70 whose front end is disposed with two latch arms 71 between which formed with a resilient plate 72 having two abutting plates 73 of a slope engaging section, a push button 74 whose bottom is disposed with a spring 75 and a slope engaging block 76 (as shown in FIGS. 15, 16), and a resilient plate 72 whose front end is formed with a slope engaging section 77. During a normal condition, when the latch arms 71 are fitted into insertion slots 81 of a fastener body 80, the slope engaging section 77 of front side of the resilient plate 72 is engaged in a fixing slot 82 of the fastener body 80. When the push button 74 is pressed down, the abutting plates 73 of resilient plate 72 are forced by the slope engaging block 76, such that the resilient plate 72 is elastically deformed and shifted backward due to a physical property of material itself, thereby disengaging the slope engaging section 77 of front side of the resilient plate 72 from the fixing slot 82.

However, as the aforementioned invention applies an elastic function of a plastic material of the resilient plate 72, the resilient plate 72 can be easily deformed after using for a very long time, which can probably indirectly cause a press-down action of the push button to be unable to quickly shift the slope engaging section 77 backward at the same time.

Accordingly, a new invention is created by the inventor to enable the article bag on the bicycle to be as comfortable and practical as a back pack.

### SUMMARY OF THE INVENTION

The primary object of present invention is to provide a quick-release hanging-plate latch structure for an article bag or basket on a bicycle handle bar, which can effectively fix the article bag or basket on the handle bar of bicycle, and facilitate assembling or disassembling.

Another object of the present invention is to provide a quick-release hanging-plate latch structure for an article bag or basket on a bicycle handle bar, wherein an assembling plate made by a metallic material can be conveniently welded on the article basket, and a hanging plate made by a plastic material is inserted into the assembling plate, so as to facilitate a latch seat to be inserted into the hanging plate with latch arms at front side of the latch seat. In addition, the latch seat is provided with a spring and an insertion tenon, so as to assure a simultaneous back shifting of the insertion tenon upon pressing down a push button, thereby facilitating an operation.

Accordingly, the present invention is primarily composed of an article bag or basket, an assembling plate, a hanging plate, and a latch seat, wherein the assembling plate is made by a metallic material is assembled with the bag or basket, and the hanging plate made by a plastic material is latched and fixed to the assembling plate to facilitate a firm assembling with the latch seat on a bicycle handle bar. In addition, when a push button is pressed down, an interior insertion tenon will be accurately shifted backward to disengage the structure, thereby achieving a true quick-release function and facilitating carrying the article bag or article basket on the bicycle for going out for shopping.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of components of the present invention.

FIG. 2 shows a schematic view of a latch seat and a hanging plate of the present invention before assembling.

FIG. 3 shows a perspective view of a latch seat of the present invention.

FIG. 4 shows a schematic view of a push button and an insertion tenon of the present invention before assembling.

FIG. 5 shows a cutaway view of a latch seat along a horizontal surface 5-5 of FIG. 2 of the present invention.

FIG. 6 shows a cutaway view of a latch seat along a vertical surface 6-6 of FIG. 2 of the present invention.

FIG. 7 shows a cutaway view of a latch seat along a vertical surface 7-7 of FIG. 2 of the present invention.

FIG. 8 shows a cutaway view of a latch seat and a hanging plate of the present invention after assembling.

FIG. 9 shows a schematic view of an offset of insertion tenon caused by pressing down a push button of the present invention.

FIG. 10 shows a perspective view of the present invention being assembled with an article basket.

FIG. 11 shows a perspective view of the present invention being assembled with an article bag.

FIG. 12 shows a schematic view of riveting a hanging plate and a back pack of the present invention.

FIG. 13 shows a schematic view of implementation of latching a back pack onto a bicycle handle bar of the present invention.

FIG. 14 shows a perspective view of a conventional quick-release locking device for an article bag.

FIG. 15 shows a cutaway view of a conventional quick-release locking device for an article bag.

FIG. 16 shows a schematic view of disengaging a conventional quick-release locking device for an article bag.

### DETAILED DESCRIPTION OF THE PREFERRED EMBODIMENTS

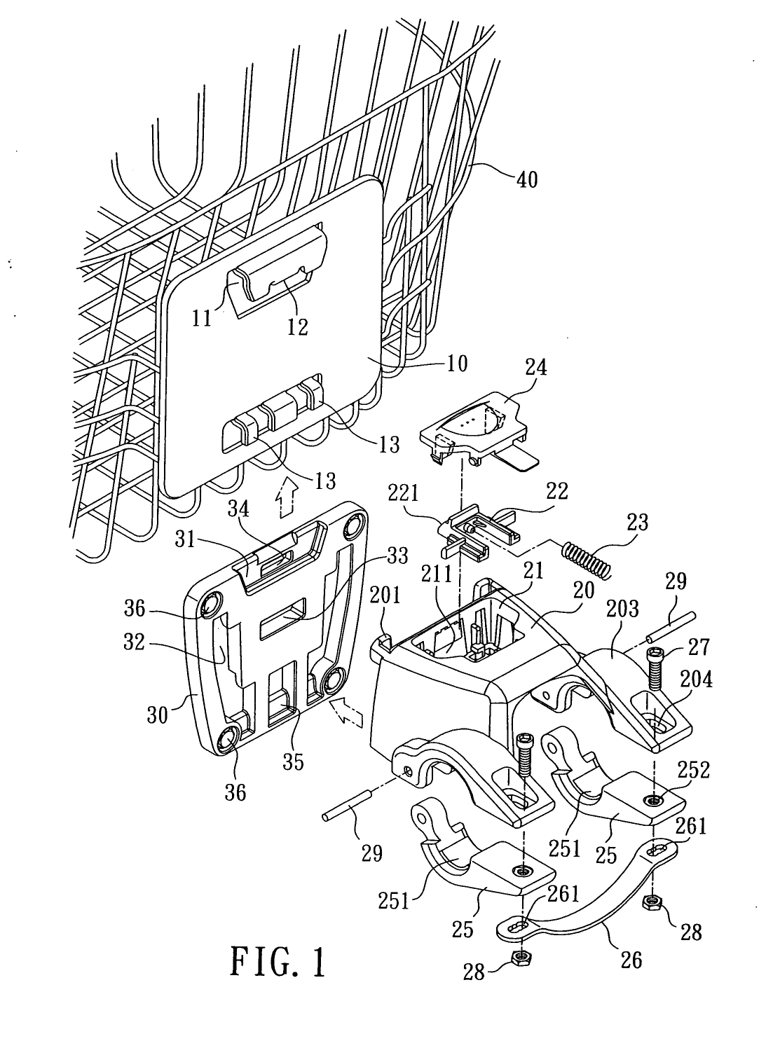

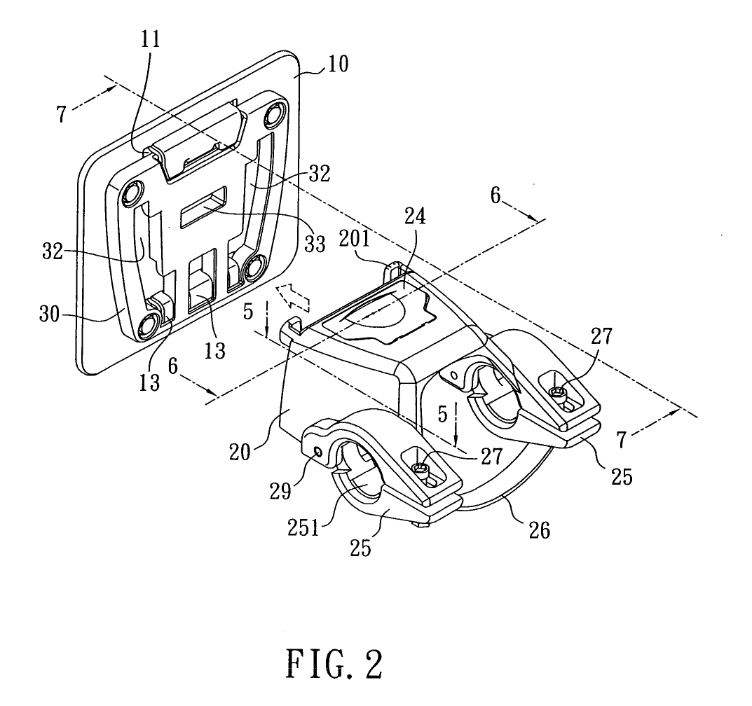

Referring to FIGS. 1 to 2, the present invention comprises primarily an assembling plate 10, a latch seat 20, and a hanging plate 30.

The assembling plate 10, which is made by a metallic material, is provided with an insertion slot 11 on an upper end thereof, a fastening plate 12 at a center thereof, and bended plates 13 at a lower end thereof. A push button sink 21 is located at an upper end of the latch seat 20, such that an insertion tenon 22, a spring 23, and a push button 24 can all be emplaced in the push button sink 21. Insertion pins 29 at two sides of bottom of the latch seat 20 are used to pivot lower clipping plates 25 between which are connected by a connection plate 26. The lower clipping plates 25 and the connection plate 26 are fastened together by penetrating bolts 27 into bolt holes 204 and tightening with nuts 28. The lower clipping plates 25 are provided with bolt holes 252 which enable the bolts 27 to be screwed in and assembled, such that the lower clipping plates 25 can be fixed on the bicycle handle bar to facilitate a fastening of the connection plate 26 whose bottom is provided with nuts 28 for screwing with the bolts 27.

Long slot holes 261 are located at two sides of the connection plate 26, so as to acquire a proper adjustment of tightening force when the connection plate 26 is crossed over a bottom of bicycle front bar 61.

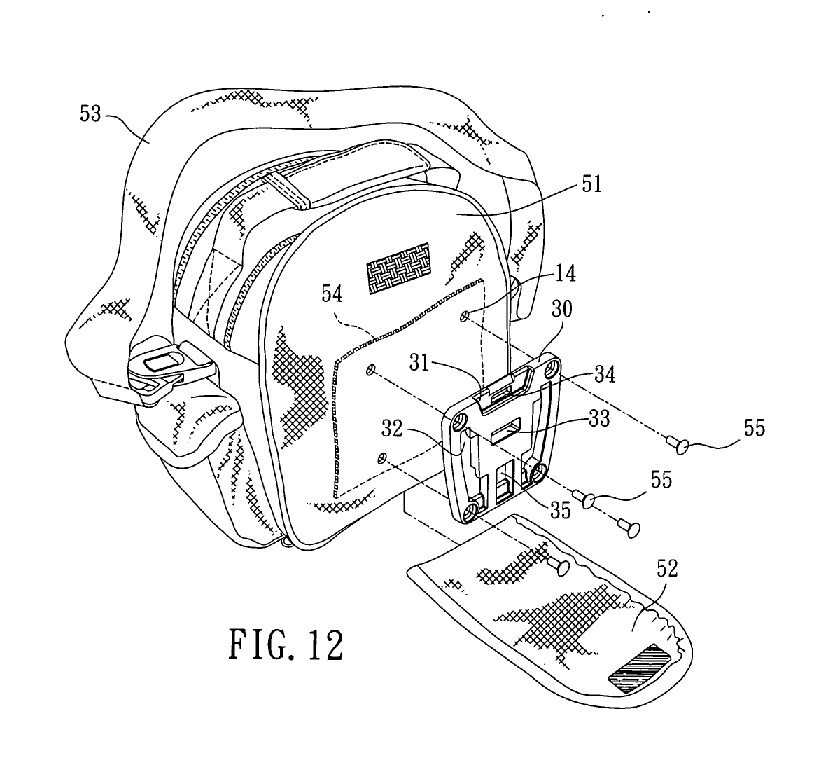

The hanging plate 30 is a square plate whose upper end is provided with a thin latch plate 31, whose two sides are symmetrically provided with two irregular-shape latch slots 32, and whose upper center position is provided with a fixing hole 33. The latch plate 31 is provided with a fastening slot 34 at a center position thereof, and a hook hole 35 at a lower center position thereof. By inserting the latch plate 31 into the insertion slot 11 of assembling plate 10, and fastening the bended plates 13 into the hook hole 35, the fastening plate 12 can be fastened into the fastening slot 34, so as to assemble the assembling plate 10 and the hanging plate 30. Dummy screw heads 36, which are connected with thin leaves, are located at four corners of the hanging plate 30, such that they can be broken to form through-holes if the hanging plate 30 is to be fixed onto an article bag 51 (as shown in FIG. 12) by riveting.

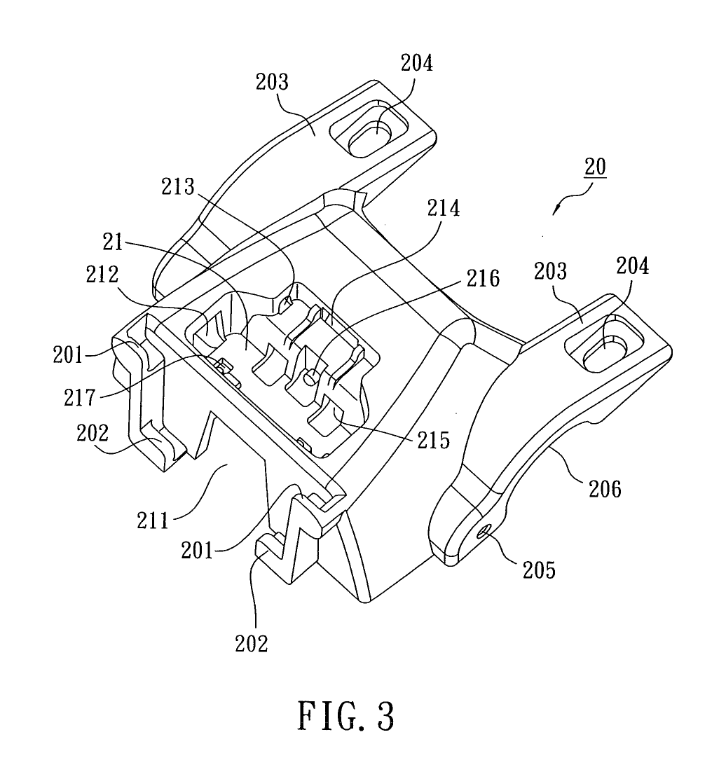

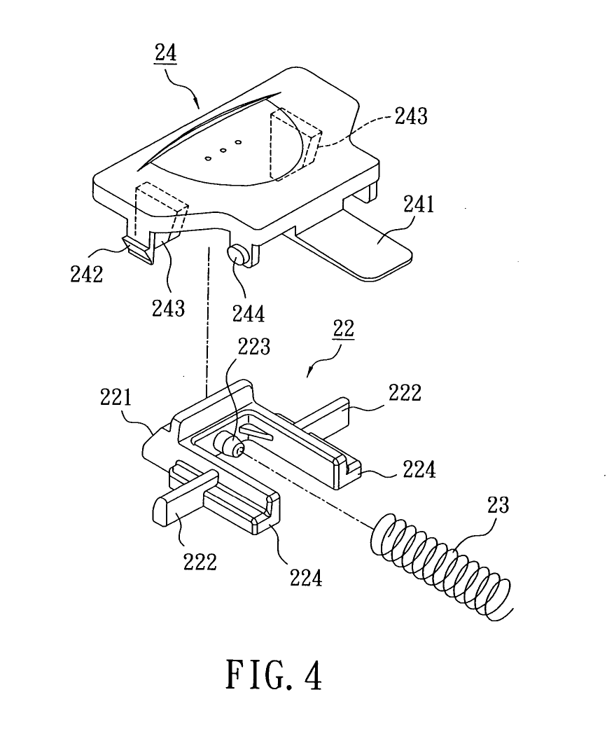

Referring to FIG. 3, a first insertion plate 201 and a second insertion plate 202 are located at a front end of the latch seat 20, and two arc plates 203 are located at two sides of a rear end of the latch seat 20. Bolt holes 204 are located on the arc plates 203, pin holes 205 are located at two sides of the arc plates 204, and arc slots 206 are located at a bottom end of the arc plates 204. A front end of the push button sink 21 is provided with an open slot 211, holes 212 and 213 are located at two sides of the push button sink 21, an insertion-plate hole 214 is located at a rear end in the push button sink 21, and a gliding slot 215, a spring fastening slot 216, and a concaved hole 217 are located at a bottom end in the push button sink 21. Referring to FIG. 4, the insertion tenon 22, spring 23, and push button 24 are emplaced in the push button sink 21, wherein a slope tenon 221 is located at a front end of the insertion tenon 22, abutting bars 222 are located at two sides of the insertion tenon 22, a shaft 223 is located at a center of the tenon body, and gliding blocks 224 are located at two sides of a rear end of the insertion tenon 22. An insertion plate 241 is located at a rear end of the push button 24, elastic fastening tenons 242 and bumps 244 are located at two sides of a rear end of the push button 24, and slant abutting plates 243 which are projected downward are located at interior sides of the elastic fastening tenons 242.

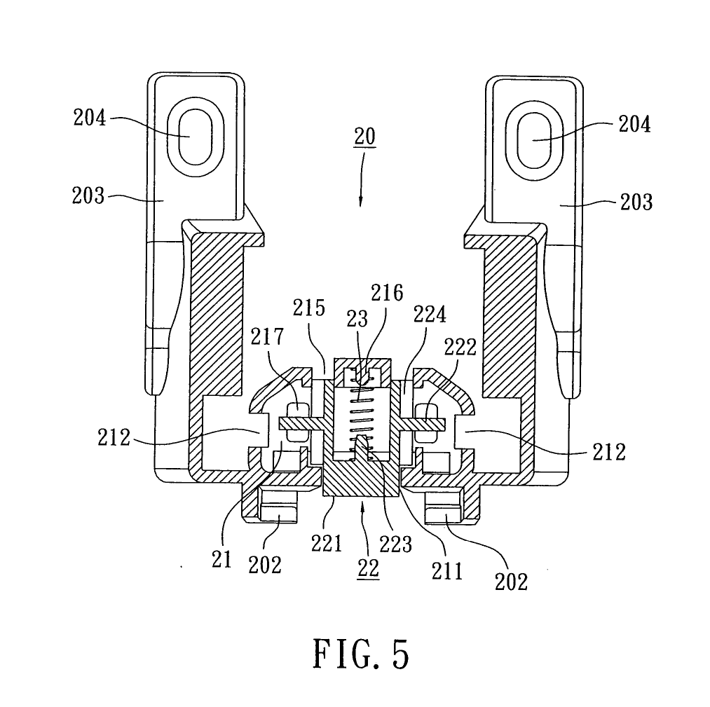

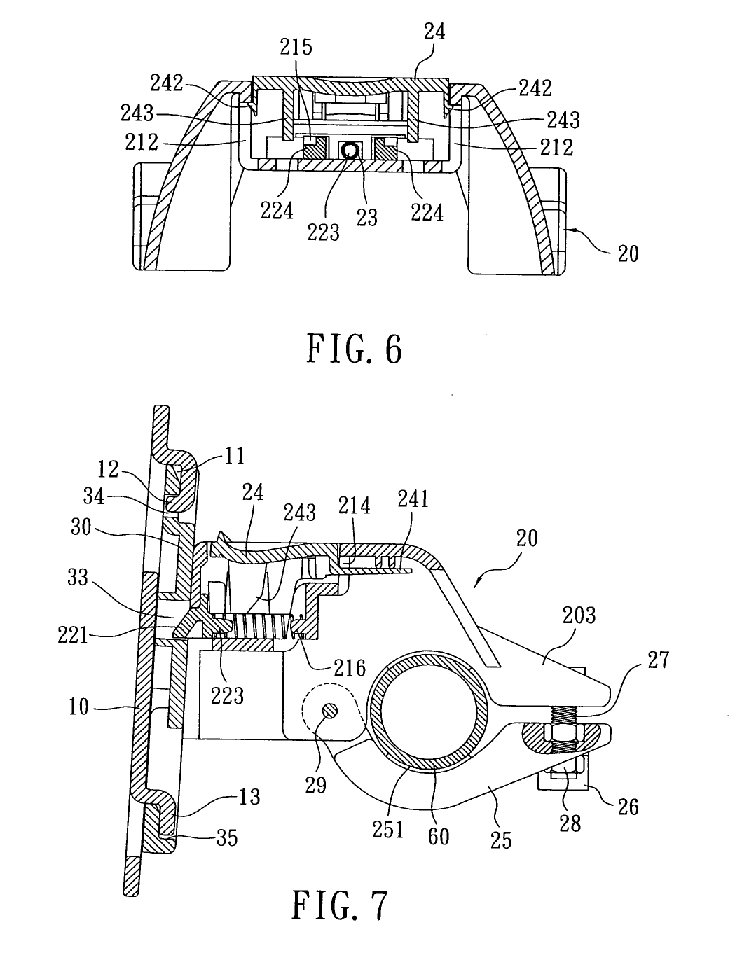

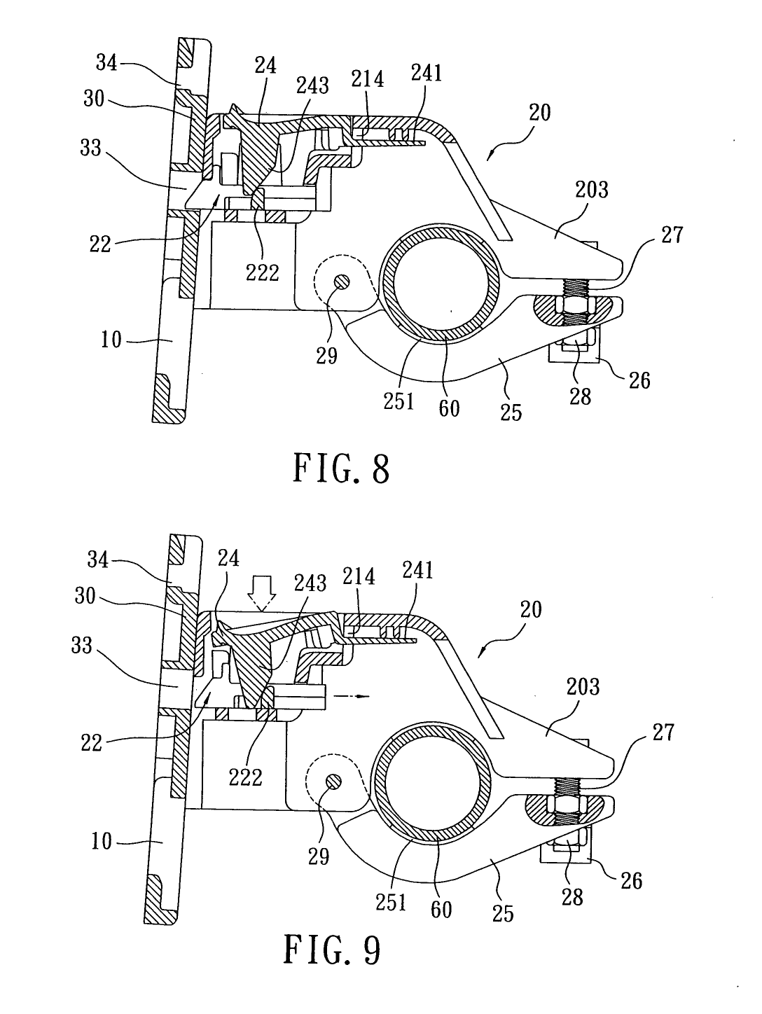

Referring to FIG. 3 and FIGS. 5 to 7, when the spring 23 is installed on the shaft 223 of insertion tenon 22 with a rear end of the spring 23 latched into the spring fastening slot 216, and the gliding blocks 224 are emplaced in the gliding slots 215, the slope tenon 221 can be forced into the open slot 211 after compressing the spring 23. Next, the push button 24 is latched into the push button sink 21 from top to bottom, such that the insertion plate 241 can be latched into the insertion-plate hole 214, the elastic fastening tenons 242 can be inserted and fixed into the holes 212, and the bumps 244 can be fixed into the holes 213, thereby causing the slant abutting plates 243 to be abutted to surfaces of the abutting bars 222 (as shown in FIG. 8). Therefore, when the push button 24 is pressed down, slant surfaces at bottom ends of the slant abutting plates 243 will be definitely pressed down on bodies of the abutting bars 222, thereby shifting the insertion tenon 22 backward (as shown in FIG. 9).

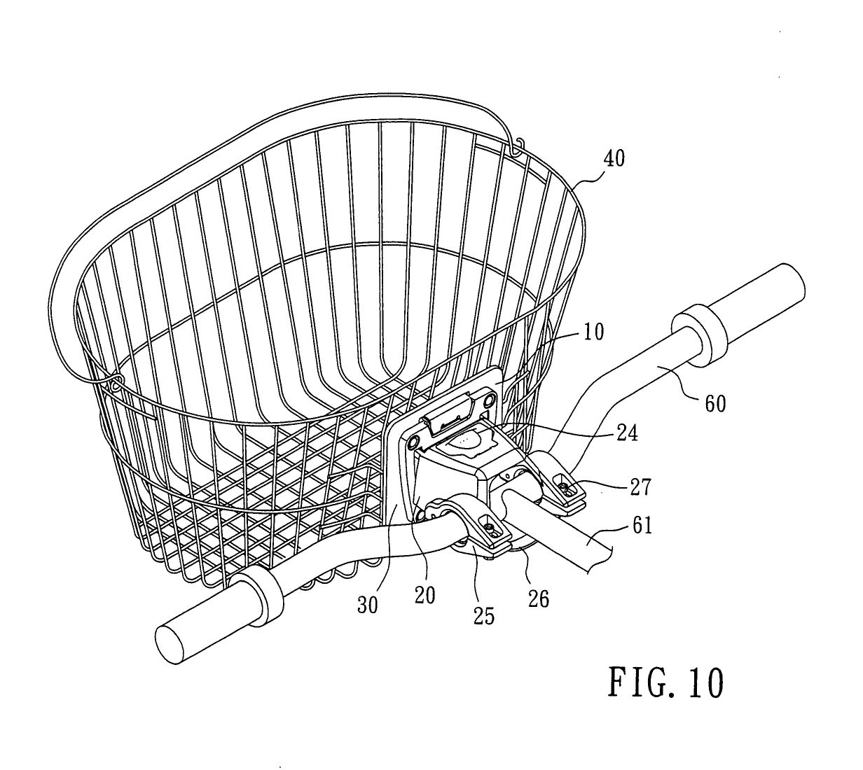

Referring to FIGS. 9 and 10, by welding the assembling plate 10 to an article basket 40, latching the hanging plate 30 at one side of the assembling plate 10, fastening and fixing the latch seat 20 on a bicycle handle bar 60 with two bolts 27, using soft pads 252 between the arc plates 203 and the lower clipping plates 25 for preventing from slipping and serving as cushions to the handle bar 60, and connecting the connection plate 26 across two sides of the bicycle front bar 61, the article basket 40 can be hung on the front handle bar when going out for shopping, to achieve an effect of firmly assembling and fixing. When it is desire to take out the article basket, the push button 24 is pressed down (as shown in FIG. 9), such that the slant abutting plates 243 at a bottom of the push button 24 will be forced to the abutting bars 222 of insertion tenon 22, and finally forming a backward shifting of the slope tenon 221 at the front end of the insertion tenon 22, thereby facilitating a disengagement of the latch seat 20 from the hanging plate 30 for removing the article basket 40.

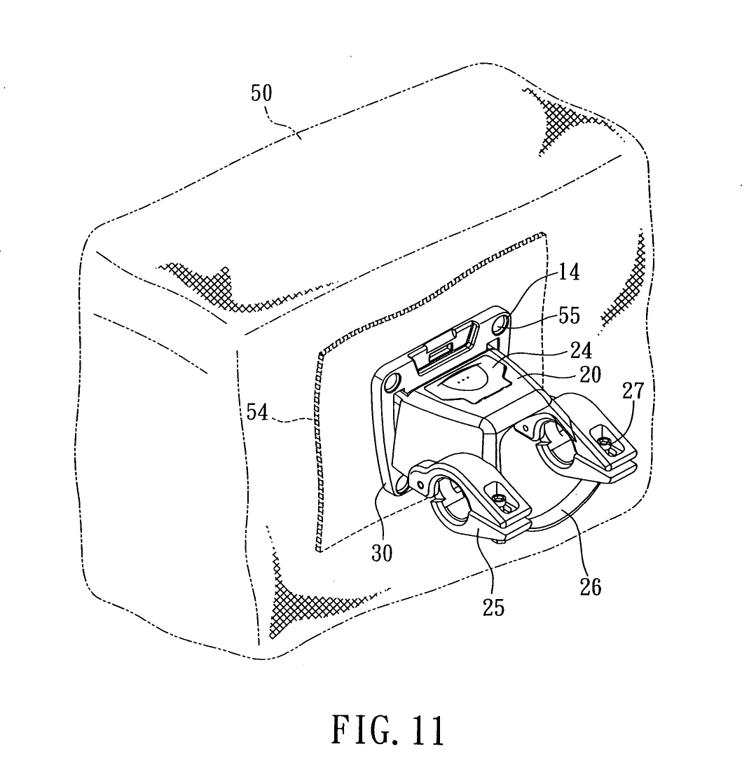

Referring to FIG. 11, through-holes 14 are located at four corners of the assembling plate 10, and a hard plastic plate 54 is located in an interior side of an article bag 50. When it is desire to assemble the latch seat 20 with the article bag 50, rivets 55 (or screws) can be used to fix the assembling plate 10 at an exterior side of the bag, and next the hanging plate 30 is fixed on the assembling plate 10, thereby achieving a same latching effect of assembling the latch seat 20 and the hanging plate 30.

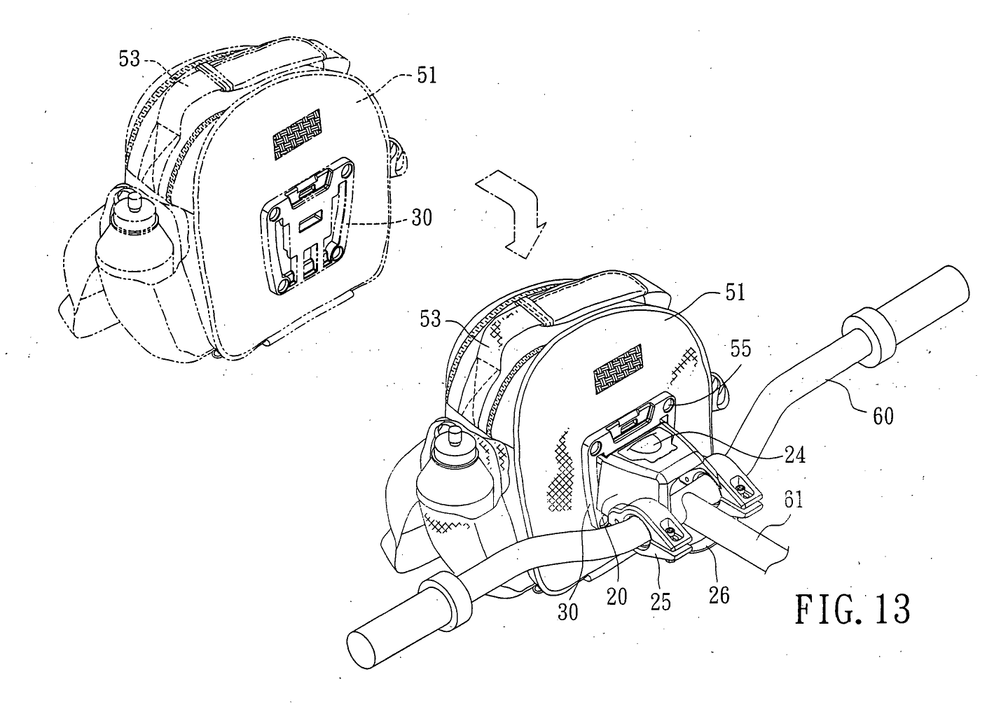

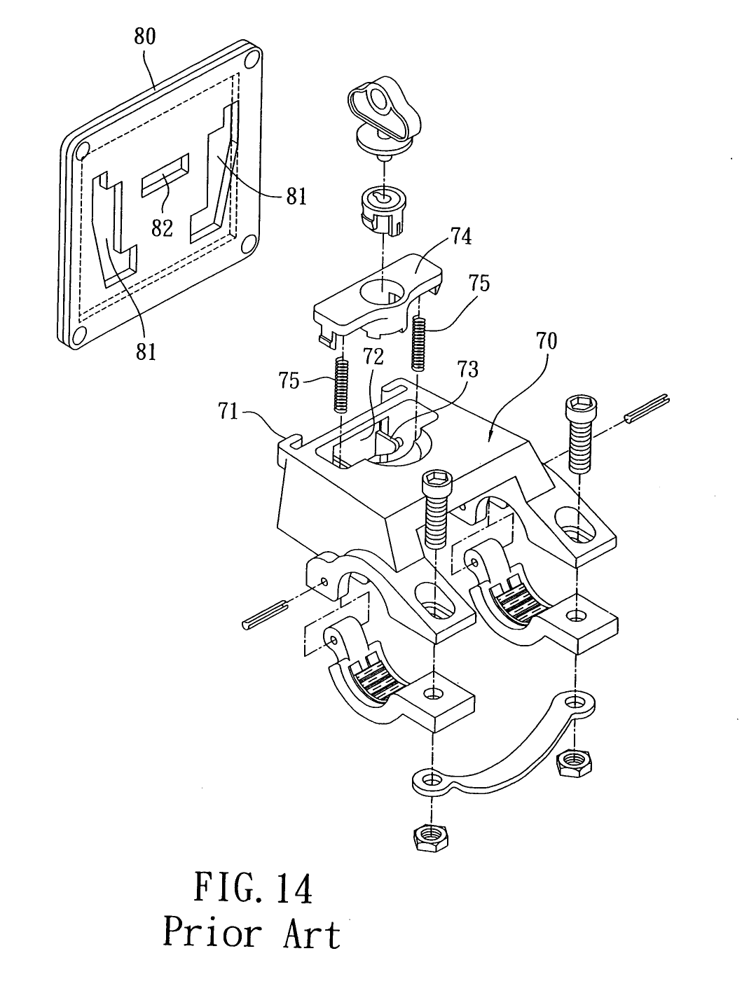

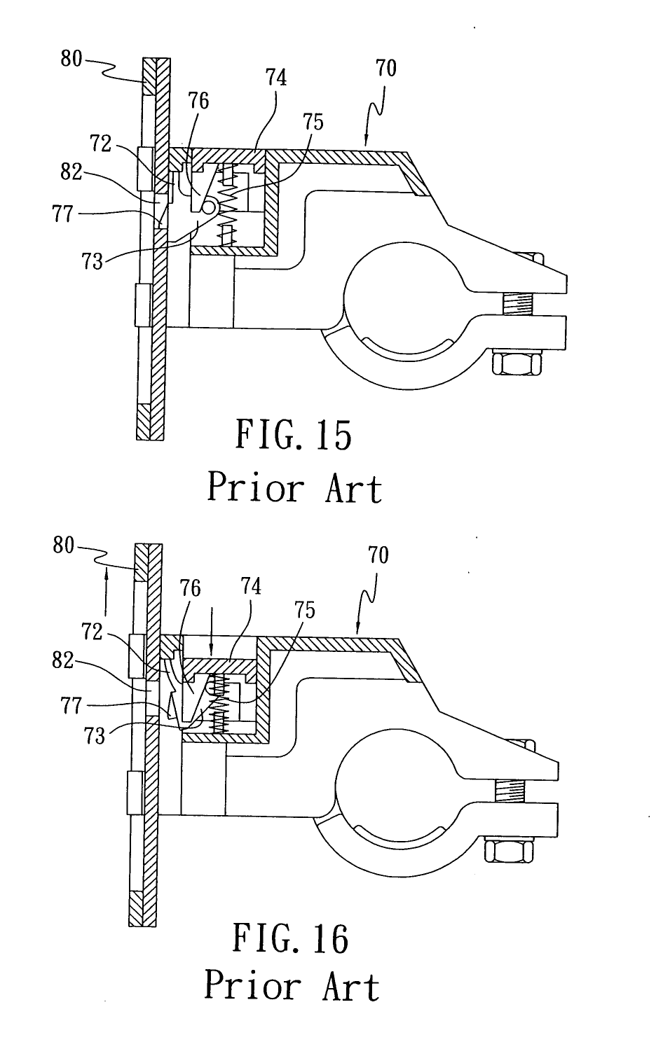

Referring to FIGS. 12 and 13, the present invention can be applied to a bicycle article bag 51 which serves as a waist pack or back pack. An adhesive section 52 is located at one side of the article bag 51, and a long back belt 53 is located at a side edge of the bag body. Through-holes 14 are located at four corners of the assembling plate 10, and a hard plastic plate 54 is located in an interior side of the article bag 51. Rivets 55 (or screws) can be used to fix the assembling plate 10 at an exterior side of the bag, and next the hanging plate 30 is fixed on the assembling plate 10, thereby achieving a same latching effect of assembling the latch seat 20 and the hanging plate 30.

Accordingly, the present invention uses simple components to assemble an article bag or article basket with an assembling plate, and next easily latches a hanging plate to the assembling plate; whereas, a latch seat is fastened on a bicycle handle bar; thereby achieving a function of facilitating latching and disassembling, and effectively increasing a practicability of the bicycle article bag or basket.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A quick-release hanging-plate latch structure for an article bag or basket on a bicycle handle bar comprising primarily a bag or a basket whose one side is fixed with an assembling plate; the assembling plate whose upper end is provided with an insertion slot, a center is provided with a fastening plate, and a lower end is provided with bended plates; a latch seat whose front end is provided with a first insertion plate and a second insertion plate, two sides of a rear end are provided with arc plates having bolt holes, two sides are provided with pin holes, an upper end is provided with a push button sink for emplacing an insertion tenon, a spring, and a push button, and two sides of a bottom are provided with insertion pins for pivoting lower clipping plates between which are connected by a connection plate, with the lower clipping plates and the connection plate fastened by bolts and nuts; a hanging plate which is a square plate and whose upper end is provided with a thin latch plate including a fastening slot at a center position and a hook hole at a lower center position, two sides are symmetrically provided with latch slots, and an upper center position is provided with a fixing hole; by inserting the latch plate into the insertion slot of assembling plate, and fastening the bended plates into the hook hole of hanging plate, the fastening plate of assembling plate being able to be fastened into the fastening slot of hanging plate, thereby assembling the assembling plate and the hanging plate; the latch seat being latched to the symmetric latch slots on the hanging plate with the first insertion plate and the second insertion plate, such that a slope tenon located at a front end of the insertion tenon can be latched to the fixing hole at the center position of hanging plate.

2. The quick-release hanging-plate latch structure for an article bag or basket on a bicycle handle bar according to claim 1, wherein through-holes are located at four corners of the assembling plate.

3. The quick-release hanging-plate latch structure for an article bag or basket on a bicycle handle bar according to claim 1, wherein a front end of the push button sink is provided with an open slot, two sides of the push button sink are provided with holes, a rear end of the push button sink is provided with an insertion-plate hole, and a bottom end of the push button sink is provided with a gliding slot, a spring fastening slot, and a concaved hole.

4. The quick-release hanging-plate latch structure for an article bag or basket on a bicycle handle bar according to claim 1, wherein a slope tenon is located at a front end of the insertion tenon, abutting bars are located at two sides of the insertion tenon, a shaft is located at a center of the tenon body, and gliding blocks are located at two sides of the insertion tenon.

5. The quick-release hanging-plate latch structure for an article bag or basket on a bicycle handle bar according to claim 1, wherein an insertion plate is located at a rear end of the push button, elastic fastening tenons and bumps are located at two sides of a rear end of the push button, and slant abutting plates which are projected downward are located at interior sides of the elastic fastening tenons.

6. The quick-release hanging-plate latch structure for an article bag or basket on a bicycle handle bar according to claim 1, wherein the assembling plate is fixed on an article basket by a welding method, and then the hanging plate is latched to one side of the assembling plate.

7. The quick-release hanging-plate latch structure for an article bag or basket on a bicycle handle bar according to claim 1, wherein the assembling plate is fixed on an article bag by a riveting method, and then the hanging plate is latched to one side of the assembling plate.

8. The quick-release hanging-plate latch structure for an article bag or basket on a bicycle handle bar according to claim 1, wherein long slot holes are located at two sides of the hanging plate.
